(19) United States
(12) Patent Application Publication
(10) Pub. No.: US 2009/0313999 A1
(43) Pub. Date: Dec. 24, 2009

(54) METHOD AND APPARATUS FOR CONTROLLING FUEL IN A GAS TURBINE ENGINE

(76) Inventors: Scott Hunter, Fairfield, OH (US); Andrew Dreikosen, Maineville, OH (US); William Myers, West Chester, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 12/120,034

(22) Filed: May 13, 2008

(51) Int. Cl. F02C 9/26; F02C 7/224; F02C 7/14

(52) U.S. Cl. 60/772; 60/730; 60/39.08

(57) ABSTRACT

A method and system for controlling fuel in a gas turbine engine including a fuel supply system channeling fuel to a combustor are provided. The system includes a first heat exchanger configured to transfer heat between a working fluid and a first cooling medium. The system also includes a second heat exchanger in series flow communication with the first heat exchanger wherein the second heat exchanger is configured to transfer heat between the working fluid and a second cooling medium. The system further includes a modulating valve configured to control the flow of at least one of the first and the second cooling media to maintain a temperature of the first or second cooling medium substantially equal to a predetermined limit.

### BACKGROUND OF THE INVENTION

This invention relates generally to gas turbine engines, and more particularly, to methods and apparatus for controlling fuel in a gas turbine engine.

Gas turbine engines typically include an inlet, a fan, low and high-pressure compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as producing useful work to propel an aircraft in flight or to power a load, such as an electrical generator.

During engine operation, significant heat is produced which raises the temperature of engine systems to unacceptable levels. These systems must be cooled to improve their life and reliability. One example is the lubrication system that is utilized to facilitate lubricating components within the gas turbine engine. The lubrication system is configured to channel lubrication fluid to various bearing assemblies within the gas turbine engine. During operation, heat is transmitted to the lubrication fluid from two sources: from heat generated by sliding and rolling friction by components like bearings and seals within a sump and from heat-conduction through the sump wall due to hot air surrounding the sump enclosure. To facilitate reducing the operational temperature of the lubrication fluid, gas turbine engines typically utilize a conventional radiator that is disposed in the air stream channeled through the engine allowing air that passes through it to cool the lubrication fluid circulating within.

In addition to removing waste heat from the lubrication fluid, gas turbine designers continuously seek opportunities to improve fuel efficiency. The specific fuel consumption of a gas turbine is inversely proportional to the fuel lower heating value, a property of the fuel that increases with temperature. However, the thermal management system of at least some known gas turbines incorporate heat exchangers that control the oil and fuel temperatures with heat exchangers sized for the highest engine operating temperature condition, such as take-off for an aircraft engine. The main heat source is the engine lubrication oil, and the heat sinks are the fuel system and ambient air. Gas turbine fuel systems have a limit on the maximum fuel temperature allowed to enter the combustor fuel nozzles. The maximum fuel temperature limit is typically set to a level that prevents coking of the combustor fuel circuit or seal damage. With the heat exchangers generally sized for the highest engine operating temperature condition, at other more benign conditions, the fuel temperature is well below the maximum limit since the heat exchangers are not actively controlled and therefore the engine is not operating as efficiently as it could.

### BRIEF DESCRIPTION OF THE INVENTION

In one embodiment, an engine thermal management system includes a first heat exchanger configured to transfer heat between a working fluid and a first cooling medium. The system also includes a second heat exchanger in series flow communication with the first heat exchanger wherein the second heat exchanger is configured to transfer heat between the working fluid and a second cooling medium. The system further includes a modulating valve configured to control the flow of at least one of the first and the second cooling media to maintain a temperature of the first or second cooling medium substantially equal to a predetermined limit.

In another embodiment, a method of controlling fuel in a gas turbine engine including a fuel supply system channeling fuel to a combustor is provided. The method includes measuring a parameter relating to a lower heating value of a flow of fuel entering the combustor and controlling the parameter using waste heat from the engine to facilitate raising the lower heating value of the fuel.

In yet another embodiment, a gas turbine engine assembly includes a rotor rotatable about a longitudinal axis, a stator comprising a plurality of bearings configured to support said rotor during rotation, and a lubrication oil supply system. The lubrication oil supply system includes an oil supply source, one or more circulating pumps configured to circulate oil between said bearings and said oil supply source. The lubrication oil supply system also includes a first heat exchanger configured to transfer heat between the oil and a first cooling medium, a second heat exchanger in series flow communication with said first heat exchanger wherein the second heat exchanger is configured to transfer heat between the oil and a second cooling medium. The lubrication oil supply system further includes a modulating valve configured to control the flow of at least one of the first and the second cooling media to maintain a temperature of the first or second cooling medium substantially equal to a predetermined limit.

### BRIEF DESCRIPTION OF THE DRAWINGS

FIG. 1 is schematic illustration of a gas turbine engine in accordance with an exemplary embodiment of the present invention;

FIG. 2 is a schematic illustration of an exemplary lubrication system that may be utilized with the gas turbine engine shown in FIG. 1;

FIG. 3 is a schematic block diagram of a thermal management system in accordance with an exemplary embodiment of the present invention;

FIG. 4 is a schematic block diagram of a thermal management system in accordance with another exemplary embodiment of the present invention; and

FIG. 5 is a graph of fuel temperature for an exemplary portion of a mission.

### DETAILED DESCRIPTION OF THE DISCLOSURE

The following detailed description illustrates embodiments of the invention by way of example and not by way of limitation. It is contemplated that the invention has general application to machine temperature management in commercial, residential and industrial applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

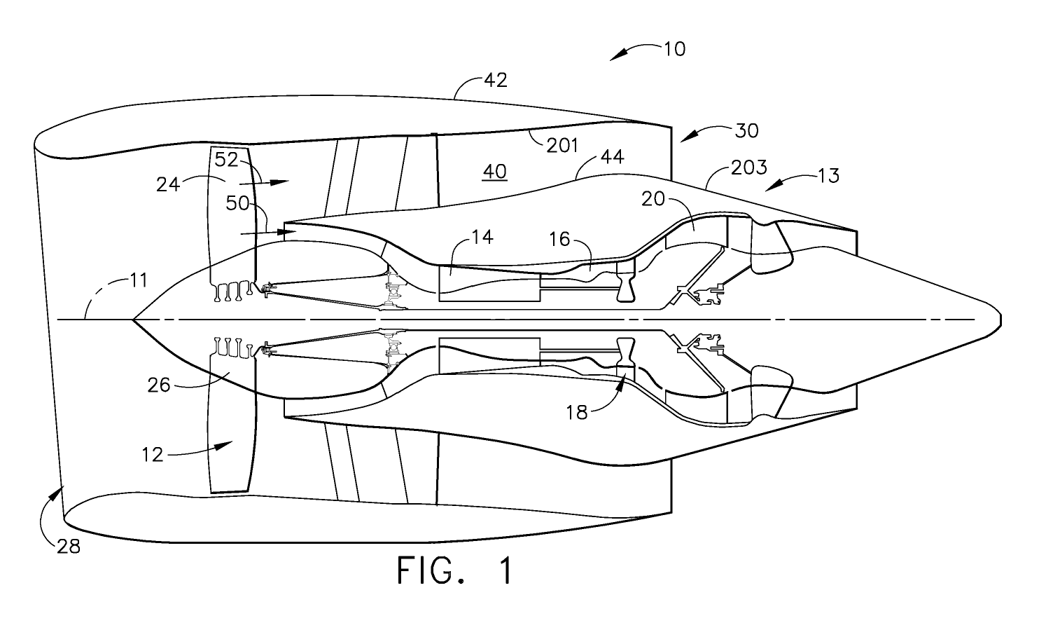

FIG. 1 is a schematic illustration of a gas turbine engine assembly 10 having a longitudinal axis 11 in accordance with an exemplary embodiment of the present invention. Gas turbine engine assembly 10 includes a fan assembly 12, and a core gas turbine engine 13. Core gas turbine engine includes a high-pressure compressor 14, a combustor 16, and a high-pressure turbine 18. In the exemplary embodiment, gas turbine engine assembly 10 may also include a low-pressure turbine 20. Fan assembly 12 includes an array of fan blades 24 extending radially outward from a rotor disk 26. Engine assembly 10 includes an intake side 28 and an exhaust side 30. Gas turbine engine assembly 10 also includes a plurality of bearing assemblies (not shown in FIG. 1) that are utilized to provide rotational and axial support to fan assembly 12, compressor 14, high-pressure turbine 18, and low-pressure turbine 20, for example.

In operation, air flows through fan assembly 12 and a first portion 50 of the airflow is channeled through compressor 14 wherein the airflow is further compressed and delivered to combustor 16. Hot products of combustion (not shown in FIG. 1) from combustor 16 are utilized to drive turbines 18 and 20 and thus produce engine thrust. Gas turbine engine assembly 10 also includes a bypass duct 40 that is utilized to bypass a second portion 52 of the airflow discharged from fan assembly 12 around core gas turbine engine 13. More specifically, bypass duct 40 extends between an inner wall 60 of a fan casing or shroud 42 and an outer wall 62 of splitter 44. As used herein, gas turbine engines include turbojet, turbofan, turboprop, open rotor (also known as open fan or an unducted fan) in either a non-geared or geared configuration.

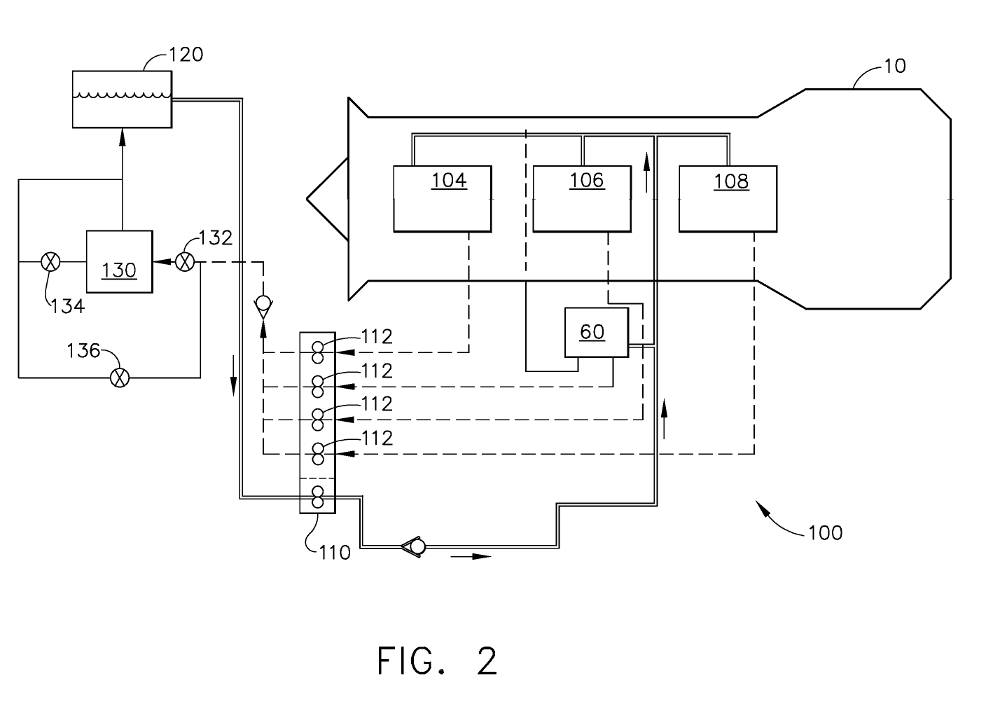

FIG. 2 is a simplified schematic illustration of an exemplary lubricating oil system 100 that may be utilized with gas turbine engine assembly 10 (shown in FIG. 1). In the exemplary embodiment, lubricating oil system 100 includes an oil supply source 120, one or more pumps 110 and 112 which circulate the oil to bearings 104, 106, 108 and to a gearbox 60 and return the hot oil to the oil supply source via a heat exchanger assembly 130 which cools it to a lower temperature. Optionally, as in the exemplary embodiment, heat exchanger assembly 130 includes an inlet valve 132, and outlet valve 134, and a bypass valve 136 that may be either manually or electrically operated.

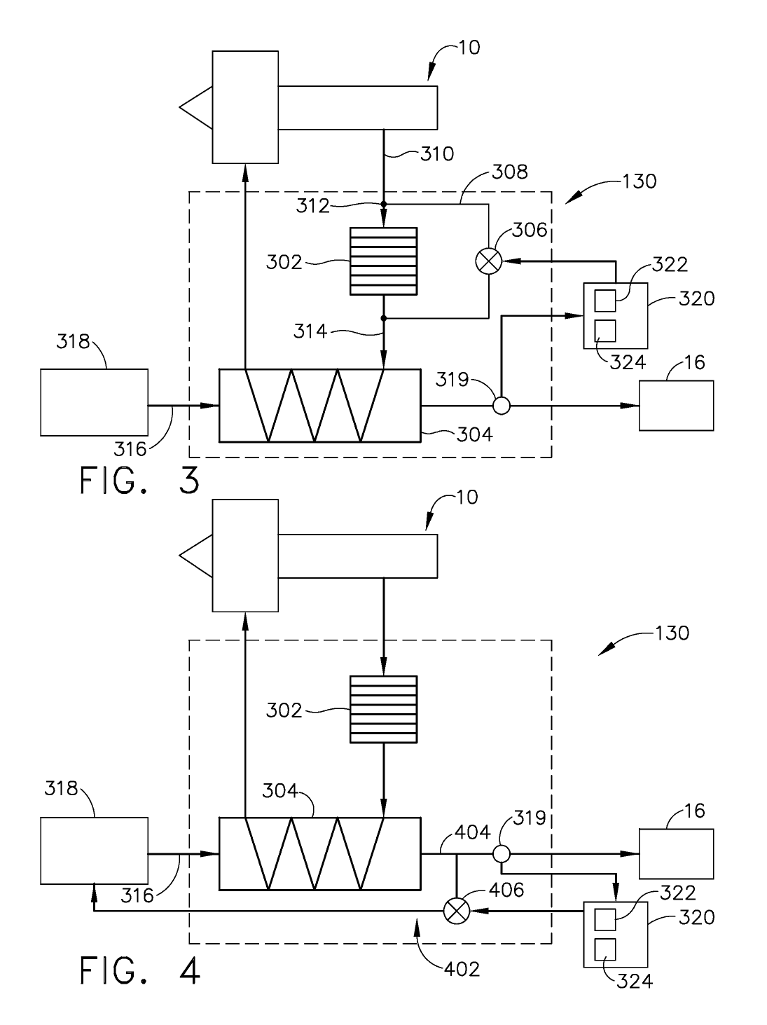

FIG. 3 is a schematic block diagram of a thermal management system in accordance with an exemplary embodiment of the present invention. In the exemplary embodiment, heat exchanger assembly 130 includes a first heat exchanger 302 in series flow communication with a downstream second heat exchanger 304. In the exemplary embodiment, first heat exchanger 302 comprises an air-cooled heat exchanger configured to cool a flow of a working fluid such as engine lubricating oil using a flow of a first cooling medium such as air. Also in the exemplary embodiment, second heat exchanger 304 comprises a fuel-cooled heat exchanger configured to cool a flow of the working fluid such as engine lubricating oil using a flow of a second cooling medium such as engine fuel. First heat exchanger 302 may be positioned within bypass duct 40. Optionally, first heat exchanger 302 may be elsewhere on engine assembly 10 or may be positioned within the airflow (not shown) about an outside of an aircraft or other vehicle, or stationary site (not shown). More specifically, although heat exchanger assembly 130 is described herein to cool oil for engine bearings, it may alternatively or simultaneously cool other fluids. For example, it may cool a fluid used to extract heat from generators or actuators used on the engine. It may also be used to cool fluids which extract heat from electronic apparatus such as engine controls, separate gearboxes or other heat generating components. In addition to cooling a wide variety of fluids utilized by a gas turbine engine assembly, it should be realized that heat exchanger assembly 130, and the methods described herein illustrate that heat exchanger assembly 130 may also cool an apparatus that is mounted on the airframe, and not part of the engine. In other applications, the heat exchanger may be mounted remotely from the gas turbine engine, for example on an external surface of the aircraft. Moreover, heat exchanger assembly 130 may be utilized in a wide variety of other applications to either cool or heat various fluids channeled therethrough.

Heat exchanger assembly 130 also includes a flow control valve 306 positioned to bypass a first portion 308 of a flow of fluid 310 around first heat exchanger 302 such that first portion 308 is not cooled by first heat exchanger 302. A second portion 312 of flow of fluid 310 passes through first heat exchanger 302 exchanging heat with the air surrounding the outside of first heat exchanger 302. As such the temperature of a flow of fluid 314 entering second heat exchanger 304 may be controlled by modulating a flow rate of first portion 308 using flow control valve 306.

Flow of fluid 314 enters second heat exchanger 304 and transfers heat between flow of fluid 314 and a flow of fuel 316 from for example, a fuel tank 318. A temperature sensor 319 monitors a temperature of flow of fuel 316 exiting second heat exchanger 304. Temperature sensor 319 transmits the monitored temperature to a temperature controller 320. In the exemplary embodiment, temperature controller 320 includes a processor 322 for executing tasks associated with flow control valve 306 to maintain a predetermined temperature setpoint of the fuel exiting second heat exchanger 304. Temperature controller 320 also includes a memory 324 for storing instructions and data. Temperature controller 320 is configured to generate a control signal based on the temperature of flow of fuel 316 received from temperature sensor 319 and a predetermined temperature limit. The generated control signal is transmitted to flow control valve 306 to modulate the flow of first portion 308. In one embodiment, the predetermined temperature limit is a constant value based on a maximum fuel temperature limit that prevents coking of combustor 16 fuel circuit or seal damage. In various other embodiments, the predetermined temperature limit is a value determined based on maximum fuel temperature limit and or other operational considerations. As such, the predetermined temperature limit may vary over the course of a mission. In the exemplary embodiment, temperature controller 320 is illustrated as being a stand-alone controller, however temperature controller 320 may also be configured as a portion of a larger controller or control system such as but not limited to an engine Full Authority Digital Engine Control (FADEC).

By opening flow control valve 306 with temperature controller 320, the oil remains at an elevated temperature as it enters downstream second heat exchanger 304, raising the fuel temperature exiting second heat exchanger 304. The fuel temperature will be lowered when all the oil is passed directly through first heat exchanger 302, lowering the fuel temperature exiting second heat exchanger 304. In the exemplary embodiment, a temperature of flow of fuel 316 increases in second heat exchanger 304. The lower heating value of fuel is directly proportional to temperature. Because the specific fuel consumption (SFC) of a gas turbine is inversely proportional to the fuel lower heating value, the SFC is not optimized when the fuel temperature is below a maximum temperature limit. By actively controlling heat exchanger assembly 130 and maintaining the fuel temperature at the maximum temperature limit over the entire mission, engine efficiency is facilitated being increased.

FIG. 4 is a schematic block diagram of a thermal management system in accordance with another exemplary embodiment of the present invention. In the exemplary embodiment, heat exchanger assembly 130 includes first heat exchanger 302 in series flow communication with downstream second heat exchanger 304. First heat exchanger 302 may be positioned within bypass duct 40. Optionally, first heat exchanger 302 may be elsewhere on engine assembly 10 or may be positioned within the airflow (not shown) about an outside of an aircraft or other vehicle, or stationary site (not shown).

Heat exchanger assembly 130 also includes a return-to-tank (RTT) circuit 402 in a fuel line 404 downstream of second heat exchanger 304. RTT circuit 402 includes a return-to-tank valve 406 that is configured to permit more fuel flow through second heat exchanger 304 when return-to-tank valve 406 is open, resulting in a lower fuel temperature entering downstream combustor 16.

In various alternative embodiments, heat exchanger assembly 130 is configured with an air-oil heat exchanger bypass (shown in FIG. 3) and RTT circuit 402 (shown in FIG. 4) in combination.

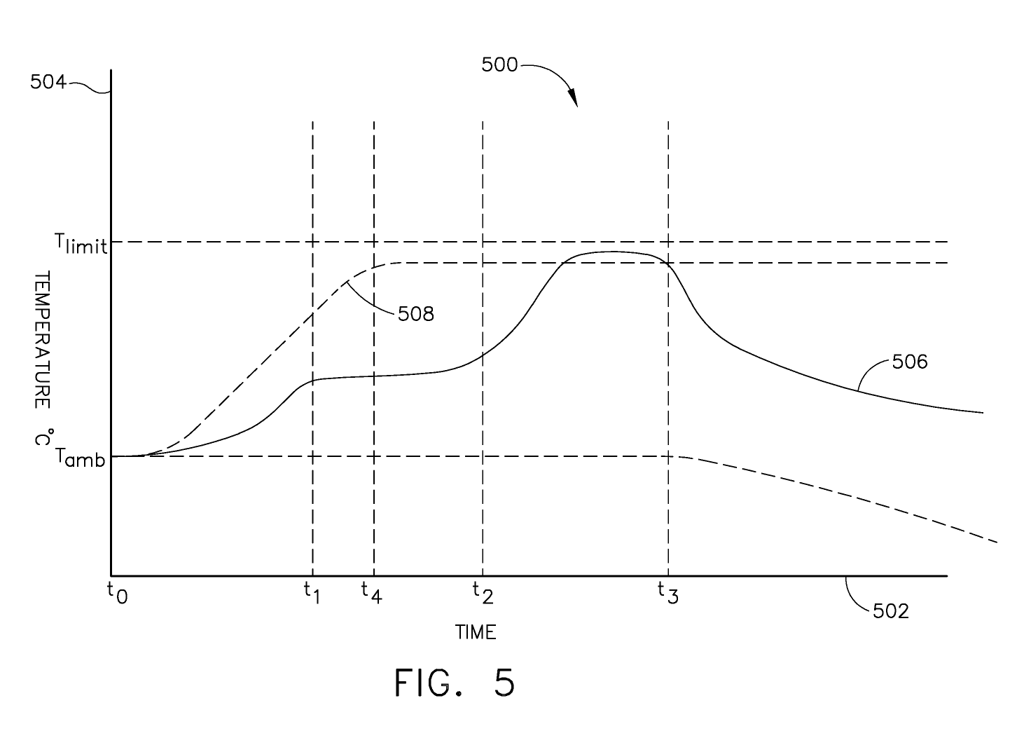

FIG. 5 is a graph 500 of fuel temperature for an exemplary portion of a mission. In the exemplary embodiment, graph 500 includes an x-axis 502 graduated in units of time and a y-axis 504 graduated in units of temperature. A first trace 506 illustrates a temperature of fuel exiting a fuel-cooled heat exchanger without thermal management. A second trace 508 illustrates a temperature of fuel exiting second heat exchanger 304 using thermal management in accordance with an embodiment of the present invention.

At a t₀, trace 506 indicates the temperature of fuel exiting a fuel-cooled heat exchanger without thermal management is approximately equal to an ambient temperature, T_{amb}. At t₀, engine assembly 10 is started and as heat is added to the fluid in lubricating oil system 100 the temperature of fuel exiting the fuel cooled heat exchanger increases. At approximately t₁, the temperature of fuel exiting the fuel-cooled heat exchanger reaches a steady state during an idle warm-up period. At t₂, the temperature of fuel exiting the fuel cooled heat exchanger increases as engine assembly 10 is loaded such as when a generator load is synched to a grid and the generator begins picking up load or when an aircraft begins taxiing in preparation for a take-off. At take-off the engine experiences the maximum load and the temperature of fuel exiting the fuel-cooled heat exchanger is approaching a fuel temperature limit, Tₗᵢₘᵢₜ. After time, T₃ the temperature of fuel exiting the fuel cooled heat exchanger varies generally according to the load on engine assembly 10 for the rest of the mission. With the temperature of fuel exiting the fuel cooled heat exchanger only approximately equal to Tₗᵢₘᵢₜ only during take-off, the SFC for the mission is greater than optimal during the overall mission.

At a t₀, trace 508 indicates the temperature of fuel exiting second heat exchanger 304 is approximately equal to an ambient temperature, T_{amb}. At to, engine assembly 10 is started and as heat is added to the fluid in lubricating oil system 100 the temperature of fuel exiting the fuel cooled heat exchanger increases. At approximately t₄, the temperature of fuel exiting the fuel-cooled heat exchanger reaches a steady state at approximately fuel temperature limit, Tₗᵢₘᵢₜ due to the modulation of flow control valve 306 and/or RTT valve 406. From t₄ onward, controller 320 manages the thermal inputs to the fuel to maintain the temperature of fuel exiting the fuel cooled heat exchanger approximately equal to Tₗᵢₘᵢₜ while also maintaining adequate cooling for lubricating oil system 100. Maintaining the temperature of the fuel exiting the fuel cooled heat exchanger approximately equal to Tₗᵢₘᵢₜ facilitates increasing the SFC to a maximum allowable, which tends to improve efficiency of engine assembly 10 through the entire mission.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in a memory such as memory 324, for execution by processor 322, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is to control the specific fuel consumption of an engine using active control of a thermal management system in the engine to maintaining the fuel temperature at a maximum limit over the mission such that the overall fuel consumption can be reduced relative to current configurations. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and system of actively controlling the amount of heat being absorbed by an engine fuel system provides a cost-effective and reliable means for maintaining the fuel temperature at a maximum limit. More specifically, the methods and systems described herein facilitate controlling the fuel temperature continuously to the maximum limit such that the fuel lower heat value is maintained at a peak value. In addition, the above-described methods and systems facilitate maintaining the specific fuel consumption of the engine optimized over the entire mission. As a result, the methods and systems described herein facilitate controlling the specific fuel consumption of the engine in a cost-effective and reliable manner.

While the disclosure has been described in terms of various specific embodiments, it will be recognized that the disclosure can be practiced with modification within the spirit and scope of the claims.

What is claimed is:

1. An engine thermal management system, comprising:
a first heat exchanger configured to transfer heat between a working fluid and a first cooling medium;
a second heat exchanger in series flow communication with said first heat exchanger, said second heat exchanger configured to transfer heat between the working fluid and a second cooling medium; and
a modulating valve configured to control the flow of at least one of the first and the second cooling media to maintain a temperature of the second cooling medium substantially equal to a predetermined limit.

2. A system in accordance with claim 1, further comprising:
a temperature sensor configured to generate an output indicative of the temperature of the second cooling medium; and
a controller communicatively coupled to said modulating valve, said controller configured to generate a valve movement command using the generated output.

3. A system in accordance with claim 2, wherein said modulating valve is configured to adjust a flow of the first cooling medium in response to a command from the controller.

4. A system in accordance with claim 2, wherein said modulating valve is configured to adjust a flow of the second cooling medium in response to a command from the controller.

5. A system in accordance with claim 1, wherein said modulating valve is configured to bypass a flow of the working fluid around the first heat exchanger.

6. A system in accordance with claim 1, wherein said modulating valve is configured to return a flow of the second cooling medium to a source of the second cooling medium.

7. A system in accordance with claim 1, wherein said second cooling medium comprises a fuel supplying the engine.

8. A method of controlling fuel in a gas turbine engine including a fuel supply system channeling fuel to a combustor, said method comprising:
measuring a parameter relating to a lower heating value of a flow of fuel entering the combustor; and
controlling the parameter using waste heat from the engine to facilitate raising the lower heating value of the fuel.

9. A method in accordance with claim 8, wherein measuring a parameter comprises measuring a temperature of the fuel entering the combustor.

10. A method in accordance with claim 8, wherein controlling the parameter comprises:
receiving a temperature of the fuel entering the combustor from a fuel temperature sensor;
comparing the received temperature to a predetermined temperature limit; and
generating a waste heat exchanger valve movement command that tends to bring the temperature of the fuel entering the combustor approximately equal to the predetermined temperature limit.

11. A method in accordance with claim 8, wherein controlling the parameter comprises bypassing a fluid around a waste heat exchanger to change the temperature of the fuel.

12. A method in accordance with claim 8, wherein controlling the parameter comprises returning a portion of the fuel to a fuel supply to change the temperature of the fuel.

13. A gas turbine engine assembly, comprising:
a rotor rotatable about a longitudinal axis;
a stator comprising a plurality of bearings configured to support said rotor during rotation; and
a lubrication oil supply system comprising:
an oil supply source;
one or more circulating pumps, configured to circulate oil between said bearings and said oil supply source;
a first heat exchanger configured to transfer heat between the oil and a first cooling medium;
a second heat exchanger in series flow communication with said first heat exchanger, said second heat exchanger configured to transfer heat between the oil and a second cooling medium; and
a modulating valve configured to control the flow of at least one of the first and the second cooling media to maintain a temperature of the second cooling medium substantially equal to a predetermined limit.

14. An assembly in accordance with claim 13, further comprising:
a temperature sensor configured to generate an output indicative of the temperature of the second cooling medium; and
a controller communicatively coupled to said modulating valve, said controller configured to generate a valve movement command using the generated output.

15. An assembly in accordance with claim 14, wherein said modulating valve is configured to adjust a flow of the first cooling medium in response to a command from the controller.

16. An assembly in accordance with claim 14, wherein said modulating valve is configured to adjust a flow of the second cooling medium in response to a command from the controller.

17. An assembly in accordance with claim 13, wherein said modulating valve is configured to bypass a flow of the oil around the first heat exchanger.

18. An assembly in accordance with claim 13, wherein said modulating valve is configured to return a flow of the second cooling medium to a source of the second cooling medium.

19. An assembly in accordance with claim 13, wherein said second cooling medium comprises a fuel supplying the gas turbine engine.

20. An assembly in accordance with claim 13, further comprising a bypass duct surrounding a core engine, said first cooling medium comprising a portion of a flow of air through the bypass duct.
